(19) United States
(12) Patent Application Publication
(10) Pub. No.: US 2004/0213384 A1
(43) Pub. Date: Oct. 28, 2004

(54) Remote access, control, and support of home automation system

(76) Inventors: Harold Gene Alles, Lake Oswego, OR (US); Brian Anthony Dalio, Lake Oswego, OR (US); Jason Benjamin Alles, Lake Oswego, OR (US); David J. Alles, Portland, OR (US); John Michael Ott, Lake Oswego, OR (US)

Correspondence Address: HAROLD G. ALLES, 4 MORNINGVIEW LANE, LAKE OSWEGO, OR, 97035, US

(21) Appl. No.: 10/249,604

(22) Filed: Apr. 23, 2003

(51) Int. Cl. H04M 3/42; H04M 1/64; H04M 11/00

(52) U.S. Cl. 379/70; 379/90.01; 379/106.01; 379/201.01

(57) ABSTRACT

A phone line interface device for home automation systems that is compatible with other home telephone devices and enables a variety of service methods provided by a service provider call center. The services include telephone customer support to answer questions and program the system, remote control of the system by telephone, and remote control, information access, and programming using the Internet.

### BACKGROUND OF INVENTION

Home automation systems use a home computer or dedicated processor to control one or a combination of appliances, lights, entertainment systems, HVAC (heating, ventilation, and air conditioning) systems, etc. These systems can be complex and must be programmed for the equipment and configuration of the house and to suit the needs and wants of the occupants. These systems usually include one or more programmers which the occupants use to issue commands and change the program when their needs and wants change. The programmer communicates with the home automation system processor. The occupants may need to change the program only infrequently, so they may not know how or forget how to use the programmer to control the system, and therefore need help satisfying their needs.

If the home automation system controls the HVAC system, it may record detailed information about the energy used. For some systems, temperature and conditioned airflow information is recorded room-by-room, day-by-day, and even hour-by-hour. An expert can analyze this information to advise the occupants on how to save energy or identify HVAC equipment or house construction or insulation problems that should be corrected.

These problems create the occasional need for the occupant to get help programming or understanding their system and the information it records. This need can be urgent if the occupant made a programming error or the system is failing to provide heating or lighting. The need may arise when no one in the house is experienced with the system, for example when a baby sitter is caring for the children.

If the system is installed in a house occupied infrequently or irregularly, remote monitoring and control by telephone or the Internet is desirable. Likewise, if one member of the household specializes in monitoring and programming the system for other members of the household, remote access allows this to continue while the specialist is away from the home.

Remote control can be used in cooperation with utility companies to control energy use during periods of shortages and peak demand. Remote access can be used to report and credit the actual energy savings to the household.

If the house is unoccupied and the HVAC system is turned off, it is useful to use a standard mobile phone to command the system to prepare the house for arrival, shortly before the occupants arrive. The home automation system should answer a call made to the house and interpret a series of tones generated by the mobile phone as a command with preprogrammed meaning, such as to turn on the HVAC system and make at least some rooms comfortable. The system should be compatible with other equipment that may be connected to a residential phone line such as an answering machine or a fax machine. If another device answers the call, the system should still respond to the tone commands.

Home automation systems can recognize system failures or household conditions that should be attended. If these occur when the house is unoccupied, it is desirable for the system to initiate a call to a service provider to report the problem. Likewise, the household may subscribe to a service where system data is periodically reported by the system and analyzed by the service. It is desirable for the system to initiate a call to report information according to a schedule that does not conflict with the household use of the phone line.

It is desirable for the system to use a shared device, method, and phone connection to satisfy all of the requirements described heretofore. Likewise, it is desirable for a service provider to use shared facilities and methods to provide all of the services described heretofore.

A number of prior systems have provided ways for one computer to remotely control another computer. Such systems have been configured to provide remote support of a novice user by an expert. U.S. Pat. No. 4,425,625 issued Jan. 10, 1984 to Seligman, et al. describes a terminal for remote diagnostics that uses a phone line, display terminals, and a device that can switch between providing a voice path and a data path over a shared phone line. This system requires the voice path to go through the voice-data switching device and is not adaptable to operate in parallel with the telephone. Likewise it is not adapted to receive commands from a telephone or be compatible with other devices connected to the telephone line.

U.S. Pat. No. 5,678,002 issued Oct. 14, 1997 to Fawcett, et al. describes a method of automated remote support and diagnostics of a computer system using a phone line shared for voice and data. This system requires the voice path to go through the voice-data switching device and is not adaptable to operate in parallel with the telephone. Likewise it is not adapted to receive commands from a telephone or be compatible with other devices connected to the telephone line. The system is designed for supporting complex operating systems and computer applications where a only a small fraction of the total information can be sent over the phone line, so special diagnostic software adapted to the operating system and application is required at the supported computer. This method is not adaptable to the needs for the home automation system described heretofore.

U.S. Pat. No. 5,983,369 issued Nov. 9, 1999 to Banoglu, et al. describes a customer support system that shares a phone line for communicating voice, video and digital data. This system requires the user to have access to a terminal other than the telephone and is adapted to educating the user rather than operating the system according to the user's request.

U.S. Pat. No. 5,325,156 issued Jun. 28, 1994 to Ulinski and U.S. Pat. No. 5,392,095 issued Feb. 21, 1995 to Siegel describe systems and methods for remotely supporting copy machine users. These inventions are specific to overcoming problems specific to copying machines and are not adaptable to supporting a home automation system.

U.S. Pat. No. 5,386,461 issued Jan. 31, 1995 to Gedney describes a HVAC thermostat that can be set remotely using a telephone connection and a sequence of tones. This invention is specific to the operation of a standard two-state thermostat using a phone line dedicated to the purpose. It is not adaptable to a programmable home automation system and where the phone line is shared with other household uses.

The prior art does not provide a practical device or method for using a shared household phone line for providing remote access and control of a home automation system for the purposes of customer support, data analysis, and remote programming and control.

Therefore, it is a purpose of this invention to provide an improved and practical device and method for remotely supporting an occupant of a home with a home automation system such that the occupant with a need calls the customer support provider using any household phone, and the customer support person retrieves information from the system, discusses the need with the occupant, and programs the system to satisfy the need of the occupant.

It is a further purpose of this invention to provide an improved and practical device and method for members of the household or authorized agents to remotely control and access the home automation system using only a standard telephone to call the household and issuing commands using tone sequences generated by the telephone.

It is a further purpose of this invention to provide an improved and practical device and method for members of the household or authorized agents to remotely control, program, and access the home automation system using an Internet connection to access a web application at a service provider call center, the call center calling the household and establishing communication with the home automation system such that the web application is used to control, program, and access the system.

It is a further purpose of this invention to provide an improved and practical device and method for the home automation system to initiate a phone call to a service provider according to a predetermined schedule or when conditions occur that require attention.

It is a further purpose of this invention to satisfy the heretofore purposes with a single device connecting the home automation system to the household phone line in parallel with telephones and other devices such as an answering machine, fax, or computer modem.

### SUMMARY OF INVENTION

A device and method of providing phone line access, control, and support of home automation systems such as multi-zone HVAC control systems. The device is interfaced to the home automation system processor and is connected in parallel to the household phone line and is equipped with a tone receiver and modem able to operate in parallel with the telephone. The support method enables a household occupant with a question or programming problem to call the service provider call center where data is read from the system and a support person discusses the question or programming problem with the customer, and programs the system if necessary. The invention further enables a household member or authorized agent to remotely access, control, and program the system using a standard telephone or an Internet connection and browser. The authorized agent can be a utility company that commands the home automation system to reduce energy usage during a peak demand time. The invention further enables the home automation system to initiate a call to a service provider call center to report problems or provide information for analysis.

### BRIEF DESCRIPTION OF DRAWINGS

Other objects and advantages of the present invention will be evident from the following detailed description read in conjunction with the accompanying drawings which illustrate the preferred embodiment.

FIG. 1 is a block diagram of the components of a home automation system and the phone line interface.

FIG. 2 is a block diagram of the components in a call center that provides customer support.

FIG. 3 is a flow diagram of the support method.

FIG. 4 is a flow diagram of the remote control method.

FIG. 5 is a block diagram of the components in a call center that provides Internet access.

FIG. 6 is a block diagram of the components in a call center that provides a combination of services such as customer support, Internet access, and remote control.

### DETAILED DESCRIPTION

The Home Automation Controller

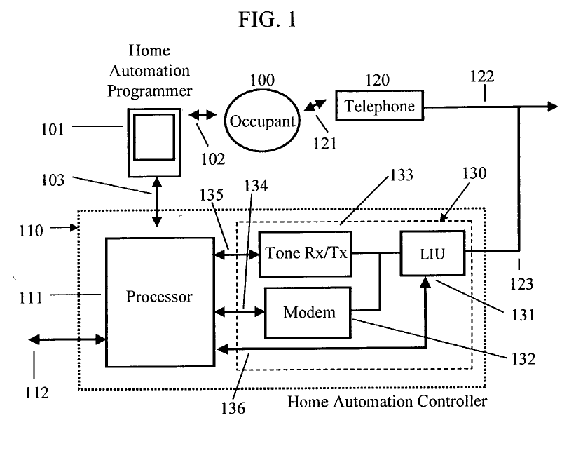

FIG. 1 is a block diagram of the components in the home where the home automation system operates. The occupant 100 can use the home automation programmer 101 to access, control, and program the home automation system. The interface 102 between the occupant and the programmer can take many forms using a combination of graphics, text, buttons, keys, touch sensitive screen, stylus, etc. The programmer may be in a fixed location or portable. The communications link 103 between the programmer and the home automation processor 111 may be wired or wireless using radio, infrared, or optical signals. In some systems, a software application executed on a personal computer is the programmer 101.

The occupant 100 also has access to a standard telephone 120 connected to the household phone line 122. The interface 121 between the occupant and the telephone is voice communications and the standard dialing keys that generate multi-frequency tones when pressed. The phone line may connected in parallel to many other household devices including telephones located throughout the house, an answering machine, a fax machine, and a modem for a personal computer.

The home automation controller 110 is comprised of a processor 111 and the phone line interface 130. The processor connection 112 connects to control devices for various household devices such as lights, entertainment equipment, and the household HVAC system.

The phone line interface 130 is connected in parallel to the household phone line by connection 123. The phone line interface is comprised of a line interface unit (LIU) 131, a modem 132, and a tone receiver and transmitter (Tone Rx/Tx) 133. The line interface unit electrically isolates the controller from the phone line, and conditions the analog signals sent to the tone receiver and the modem. Likewise, the line interface unit conditions the signals from the tone transmitter and modem to the phone line.

The line interface unit 131 can detect a ringing signal on the phone line, another telephone device going off-hook to answer or initiate a call, and the device going on-hook to terminate a call. The ring, off-hook, and on-hook detection events are communicated to processor 111 via connection 136. The line interface unit can also detect a call being terminated by a hang-up signal caused by the calling person or calling device ending the call. The processor can command the line interface unit via connection 136 to go off-hook to answer or initiate a call and to go on-hook to terminate a call.

The tone receiver and transmitter 133 can detect all standard multi-frequency telephone signals and all call progress signals such as dial tone and busy signal. The detection of these signals are communicated to the processor via connection 135. The processor can command the tone receiver and transmitter to generate any of the standard multi-frequency telephone signals via the connection 135.

The modem 132 can decode at least one standard method for transmitting digital data over a phone line. The decoded data is communicated to the processor via the connection 134. The modem can encode digital data sent from the processor via connection 134 into at least one standard method for transmitting data over a phone line. The processor can command the modem to receive data and to send data via the connection 134.

In the preferred embodiment, the tone transmitter and receiver, modem, and line interface unit control functions of the phone interface unit 130 are provided by an integrated circuit model CMX878D1 manufacture by CML Microcircuits, Oval Park, Langford, Maldon, Essex, CM9 6WG, England. Additional standard discrete components are used to provide electrical isolation from the phone line. The connections 134, 135, and 136 are combined into a single bit serial interface to reduce the number of connections to the processor. There are many other standard components known to those ordinarily skilled in the art that can be combined to provide these functions.

The Service Provider Facility

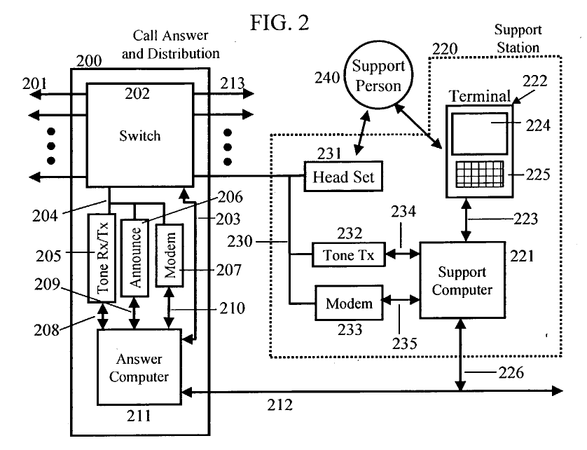

FIG. 2 is a block diagram of the equipment at the call center of a service provider. Multiple phone lines 201 connect to an automatic call answer and distribution system 200. The distribution system is comprised of a telephone switch 202 controlled by the answer computer 211 via connection 203. The telephone switch includes the circuits necessary to connect to standard phone lines and to answer and originate standard telephone calls. In response to commands form the answer computer, incoming calls can be connected via connection 204 to a tone transmitter 205, a recoded voice announcement device 206, and modem 207, each controlled by the answer computer via respective connections 208, 209, and 210. Modem 207 uses the same standard methods of data encoding and decoding on a phone line as modem 132 in FIG. 1.

The answer computer 211 executes a call processing application that answers incoming calls with prerecorded announcements directed to the occupant making the call and controls the tone receiver and transmitter (Tone Rx/Tx) 205 and modem 207 to communicate with the home automation controller.

The call center has multiple support stations 220 and support people 240. The call processing application assigns answered calls via connections 213 to the support people in a way that equalizes the work load of each support person and the waiting time for each call. The answer computer 211 is connected to a digital data network 212 that connects to each support station. Data received by the answer computer 211 from the home automation controller is sent to the corresponding assigned support station.

The support station 220 is comprised of a support computer 221 connected via interface 223 to a terminal 222 with a display 224 and keyboard 225. The support computer is connected to the digital data network 212 via connection 226. The connection 213 from the answer and distribution system connects in parallel via interface 230 to a head set 231, a tone transmitter 232, and modem 233. Modem 233 uses the same standard method of data encoding and decoding on a phone line as modem 132 in FIG. 1. The tone transmitter 232 is connected to the support computer via connection 234. The modem 233 is connected to the support computer via connection 235.

The support person wears the headset 231 and is able to listen to and talk to the occupant making the call for support. The support person uses the terminal to interact with the support application program executed by the support computer 221. In response to commands entered at the terminal by the support person, the support application controls the tone transmitter (Tone Tx) 232 to send commands and the modem 233 to receive and send data. The support application also provides the support person an interface to the home automation controller with at least the same functionality as the home automation programmer 101.

Servicing a Customer Support Call

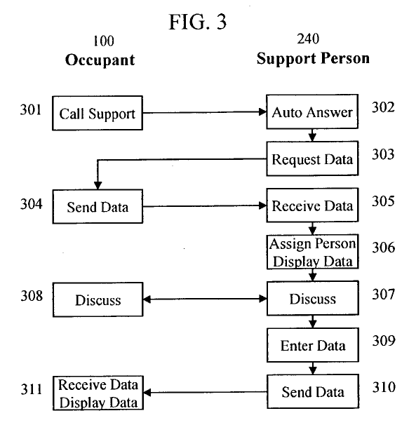

FIG. 3 is a flow diagram of the steps of the method to provide customer support. In step 301, the occupant initiates a call to the call center using any telephone in the home. In step 302, the automated call answer and distribution system at the call center answers the call and uses the announcement device to play a recorded announcement confirming the call has reached customer support and instructing the occupant to remain quite while information is transferred from the home automation system. Alternatively, the announcement may ask for permission to read data, explaining that the call can be handled more promptly when a support person becomes available. The occupant would give permission by pressing a specific telephone key.

In step 303, the call answer system makes a request for data to the home automation controller by sending a predetermined series of tones using the tone transmitter. The home automation controller monitors the phone line via the line interface unit. When an off-hook condition is detected, the processor enables the tone receiver to monitor the phone line for tones. In step 304, when the predetermined tone sequence is recognized, the processor enables the modem to send the requested data. The sequence of tones to request data is chosen to be distinguishable from any tone sequence used to place calls, so that the home automation controller does not mistake a normal phone call for a command to send data. Alternatively, the home automation controller can collect the telephone number digits as calls are placed. The home automation controller can be preprogrammed with the phone numbers of the call centers that can provide services, and enable data transfer only when the telephone number matches that of a call center.

In step 305, the call answer system uses the modem to receive the data sent by the home automation controller. The data includes information that identifies the home automation system, that can be matched to information stored in a database maintained by the service provider. This database can contain information about the installation and configuration of the home automation system, information about the house and the occupants, information about past support calls, and historical information gathered and reported by the home automation system. For example, if the HVAC system is controlled and monitored by the home automation system, the information may be detailed room-by-room energy use data over several years.

In step 306, the call answer system assigns a support person to the call, sends the received data and associated information from the service provider's database to the support station used by the support person, and makes a voice connection 213 to the support station. The information is displayed by the support computer on the terminal so that the support person has access to all available information about the household and the home automation system configuration, history, and current performance.

In step 306, if a support person is not immediately available, the call answer system may play prerecorded announcements to the occupant regarding estimated waiting time until a support person will be available or regarding other information about support services or the home automation system.

In step 307, the support person begins a discussion with the occupant to confirm that the information is correct and to understand the purpose of the call. In step 308, the occupant describes the purpose of the call. The discussion continues until the occupant has a satisfactory answer or solution. If only an answer is required, the occupant ends the call. All information about the call is stored in the service provider's database.

If the solution requires reprogramming the home automation system, in step 309 the support person enters the program data using the keypad on the terminal. The occupant remains on line while the support person programs the system and describes the actions to the occupant.

In step 310, the new program data is sent to the home automation controller. The tone transmitter of the support station is used to send sequence of tones that command the home automation controller to receive program data. Then the support station's modem is used to send the program data.

In step 311, the home automation controller recognizes the tone sequence as a command to receive program data and the processor enables the controller's modem to receive the program data. After the program data is received, the occupant can use the home automation programmer to view the new program. The discussion between the occupant and support person may continue to verify that the new program will satisfy the customer's needs or answer the customer's questions.

Remote Control Using a Standard Telephone

The processor in the home automation controller can be programmed so that a standard telephone can be used to command the execution of preprogrammed commands. The home automation programmer is used to specify a sequence of digits that can be dialed using the tone generator of a standard telephone, and to specify a command to be associated with the specified sequence of digits. Multiple digit sequences and commands can be programmed.

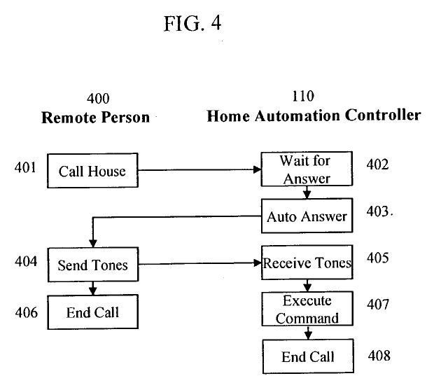

FIG. 4 is a flow diagram of the steps that provide remote control. In step 401, the remote person places a call to the house using a standard telephone. In step 402, the line interface unit in the home automation controller detects the ringing signal and alerts the processor. The line interface unit monitors the phone line for an off-hook signal from another telephone device connected to the phone line.

In step 403, if after a predetermined number of rings there is no off-hook signal, the processor commands the line interface unit to go off-hook, then commands the tone transmitter to generate a predetermined tone sequence recognizable to the remote person as an answer signal from the home automation controller. The processor then uses tone receiver to monitor the phone line for a sequence of tone signals representing a sequence of digits that can be dialed using a standard telephone, and compares the received sequence of digits to the preprogrammed sequences associated with commands. Alternately, if some other telephone device goes off-hook before the predetermined number of rings, the processor likewise monitors the phone line for a sequence of digits that match the preprogrammed commands.

In step 404, the remote person listens for an answer from the house. The phone could be answered by an occupant, by another telephone device, or by the home automation controller. If the phone is answered by an occupant, the remote person informs the occupant of the operation, and asks the occupant to not talk. If the phone is answered by an answering machine, the remote person waits until the prerecorded greeting is finished. If the phone is answered by some other telephone device, the remote person may need to take some action to disable the device. In any case, as soon as the phone line is substantially quite, the remote person can use the telephone to send the sequence of digits that corresponds to the desired command.

In step 405, the processor monitors the tone sequence using the tone receiver and the corresponding sequence of received digits is compared to the preprogrammed sequences of digits that correspond to preprogrammed commands. If a match is detected, in step 407 the corresponding command is executed by the processor. The home automation controller continues to monitor the phone line as long as the call remains connected. The remote person can issue additional commands or terminate the call in step 406.

In step 408, if the line interface unit went off-hook to answer the call, when it detects the call hang-up signal, the processor ends the call by commanding the line interface unit to go on-hook. If the some other telephone device answered the call, the line interface unit monitors the phone line for the on-hook signal from that device which ends the call.

Remote Control Using an Internet Connection

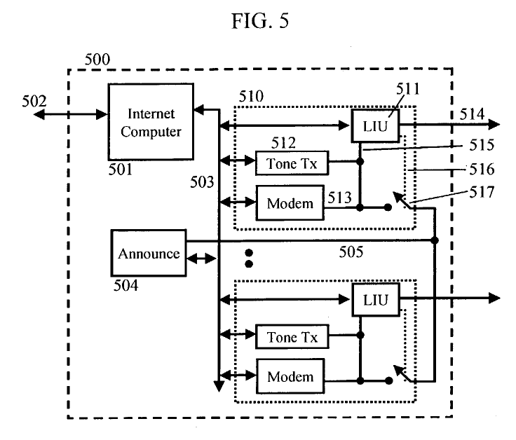

FIG. 5 is a block diagram of an Internet server 500 provided by a service provider in a call center. The Internet server enables home automation systems to be accessed and programmed using an Internet connection. The Internet server is comprised of an Internet computer 501 connected to the Internet via a connection 502. The Internet computer has a control bus 503 that connects to an announcement machine 504 and multiple phone line controllers 510.

Each phone line controller is comprised of a line interface unit (LIU) 511, a tone transmitter (Tone Tx) 512, and a modem 513, each of which is connected to the control bus 503. The line interface unit 511 is connected to a phone line 514. The line interface unit provides electrical isolation and conditions the analog signal for connection via interface 515 to the tone transmitter 512 and the modem 513. The announcement machine output 505 can be connected to the analog signal 515 by a switch 517 controlled by the line interface unit 511 via interface 516. Each phone line controller is connected to a different phone line, and multiple phone line connections to different home automation controllers can be processed at the same time.

The Internet computer provides a customized personal web page for each customer of the support service. Access to this web page is protected by password. A database accessible by the Internet computer stores information about the customer and the customer's home automation system. The customer's web page also provides an web enabled application that replicates the functionality of the home automation programmer.

When the customer accesses the web enabled programmer from their web page, the Internet computer accesses the database to find the customer's home phone number and other information about the home automation system. The Internet computer controls the line interface unit 51 land the tone transmitter 512 to place a call to the customer's home. When the call is answered, the internet computer commands a predetermined tone sequence to be generated by tone generator 512. This tone sequence is recognized by the home automation controller as a command to enable the home automation controller's modem to establish data communications.

In the event the customer's phone is answered by an occupant or a telephone device other than the home automation controller, it may interfere with the tone sequence or the data communication between the modems of the home automation controller and the Internet server. If data communications is not established, the Internet computer 501 commands the line interface unit 511 to connect the analog signal 515 to the output 505 of the announcement machine 504. The Internet computer then commands the announcement machine to play a recording describing the purpose of the call and requesting the occupant to remain quite for a few seconds and then hang up. After the announcement, the tone sequence is sent again and data communication between the modems is attempted. Once the home automation controller recognizes the tone sequence, the home automation controller's processor commands the home automation controller's line interface unit to go off-hook to ensure the other telephone device does not terminate the call by going on-hook. The steps of making an announcement, sending the tone sequence, and attempting data communication using the modems are repeated a predetermined number of times. If data communications cannot be established, an appropriate message is displayed on the customer's web page. The customer may need to directly call the home to talk to an occupant or take some action to disable the interfering telephone device connected to the household phone line.

Once data communication is established between the modems, the customer uses a standard Internet browser and the web enabled application to view information from the home automation controller sent via the modem. The customer can also program the system as though using the home automation programmer. The program data is sent to the home automation controller via the modems. The phone connection is maintained until the customer navigates from the web enabled application to another web page. Before leaving the web enabled application, a message is displayed informing the customer of the programming actions sent to the home automation controller and asking the customer to confirm ending the programming session. When the customer ends the session, the Internet computer send a digital message via modem to the home automation controller to end the phone call. In response, the home automation controller's processor commands the line interface unit to go on-hook.

Other Uses for the Phone Line Interface

The processor can make a phone call using the phone line interface. This capability can be used to report information or problems to a service provider independent of any action by an occupant. The call can be scheduled to occur at a time when the household phone line is not used and in a way to avoid call overloading at the call center of the service provider. The call answer system 200 shown in FIG. 3 can be used to automatically process a call from the home automation controller. If the calls are scheduled for late evening and early morning, the call answer system will have unused capacity because there will be few support calls from occupants.

To report data, the processor uses the phone line interface to call the call answer system at the call center As soon as the call is answered by the call answer system, the processor commands the tone transmitter to send a predetermined tone sequence that identifies the call as an automatic data report. When the call answer system answers a call, the tone receiver is enabled to detect tones, and the answer computer monitors the tone receiver for the predetermined sequence of tones. If the predetermined sequence of tones is detected, the modem is enabled to communicate with the home automation controller modem. If there are no tones detected, then the call answer system processes the call as though an occupant placed a support call.

As an example, if the home automation system controls the HVAC system and records energy use data, this information can be reported weekly or monthly to a service provider for analysis. The analysis can compare the household's energy use for heating or cooling with other households. By including the programmed temperature schedules in the analysis, differences in energy use can be attributed to the household temperature schedules, the efficiency of the HVAC equipment, or the insulation. By comparing current data with historical data for the house, deteriorations in insulation or HVAC equipment can be detected. If a room or one area of the house begins to require more energy, then the insulation or a window may be failing. If the house uniformly requires more energy, then the furnace or air conditioner may be failing or in need of service. The results of the analysis can be reported to the customer by email or regular mail. This analysis could be entirely automated or evaluated by an expert, particularly when something unusual is detected. If the analysis service is integrated with call support, the call support person could analyze data and prepare reports when not occupied with a support call.

As a second example, if the home automation system controls the household HVAC system, an electric utility with an excessive peak load demand can command the home automation system to reduce energy usage. A household participating in such a program would program a set of temperature schedules specifically for energy savings. Perhaps only a single room would be air conditioned while the remainder of the house was unconditioned. The home automation system is programmed so that this energy saving set of temperature schedules is used when the home automation controller recognizes a predetermined sequence of tones in an answered phone call. This tone sequence is provided to the utility or the service provider representing the utility. When an energy reduction is needed, a call is placed to each participating household, and the predetermined tone sequence is sent as soon as the call is answered. The home automation controller's processor recognizes the tone sequence using the tone receiver, and begins using the energy saving temperature schedules. The Internet server 500 shown in FIG. 5 can be used to make the calls on behalf of the utility.

The energy saving temperature schedules could be cancelled in a variety of ways, depending on the program offered by the utility. The schedules could automatically terminate after a predetermined amount of time such as 4 hours. They could automatically terminate at a predetermined time such as 8 pm. They could terminate when a phone call is received with a different predetermined tone sequence. An occupant could also terminate the energy saving temperature schedules using the home automation programmer.

A peak period energy reduction program is most effective if the utility provides incentives. For example, a surcharge can be applied to energy used during the peak period, or the energy saved during the peak period could be use during an off peak period for a reduced price. The home automation system can record the actual energy used during the peak period and report the data to the service provider or the utility using the automatic reporting described in the first example heretofore described.

Other Embodiments of the Service Center

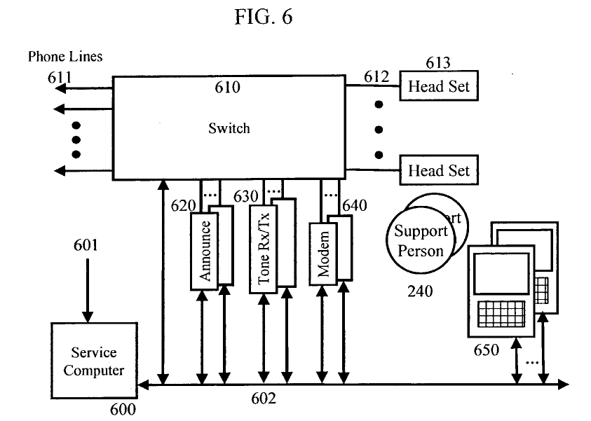

The service provider components heretofore described can be arranged in many ways, depending on the number of customers served and the types of services provided. For example in FIG. 6, the function of the answer computer, the support computer, and the Internet computer are provided by a single service computer 600. The service computer is connected to the Internet via a connection 601 and has a control bus 602 connected to all the other components such that the service computer can control the components.

The telephone switch 610 is connected to one or more phone lines 611, one or more analog lines 612 connected to one or more head sets 613 used by one or more support people, and one or more analog lines connected to the analog inputs and outputs of one or more announcement devices 620, one or more tone receivers and transmitters (Tone Rx/Tx) 630, and one or more modems 640. The functions of the announcement devices 206 (of FIG. 2) and 504 (of FIG. 5) are provided by the announcement devices 620. The functions of the tone receivers and/or transmitters 205 (of FIG. 2), 232 (of FIG. 2), and 512 (of FIG. 5) are provided by the tone receivers and transmitters 630. The functions of the modems 207 (of FIG. 2), 233 (of FIG. 2), and 513 (of FIG. 5) are provided by the modems 640.

One or more support persons each uses a head set 613 and a terminal 650 connected to the control bus 602. The service computer 600 uses a multi-processing operating system to concurrently execute the different applications used by the support persons and the applications used to provide automated services. The number of devices 620, 630, and 640 are chosen to provide sufficient capacity for each function to support the required mix of automated services and support calls to the support people. For example, during a typical support call, most of the time is spent in discussions between the support person and the occupant, so there are more terminals 650 than announcement devices 620, tone receivers and transmitters 630, and modems 640.

The devices and methods described in the heretofore are only representative of the kinds of support service provided by the present invention, and should not be construed to limit the scope of the invention.

1. A method of providing telephone support to a user of a home automation system comprising a processor, a programmer, a tone receiver, a modem, and a parallel connection to a household phone line, where the user has a question about the system and makes a call to a customer support provider, the method comprising:
1) providing an automatic answering means for the call;
2) providing a means for automatically requesting data from the processor using a tone signal sent over the phone line and recognized by the tone receiver;
3) providing a software means in the processor, responsive to the recognized tone signal and sending the requested data using the modem and the phone line;
4) providing a means for receiving the requested data;
5) assigning a support person to discuss the question with the user;
6) providing a means for representing the requested data to the support person such that the support person has sufficient information to answer the question; and
7) using the phone line such that the user asks the support person the question and such that the customer support person and the user discuss the question and such that the customer support person provides a satisfactory answer to the question;
whereby the user is satisfied by the response of the customer support person and satisfied by the support method.

2. The method of claim 1 wherein the requested data further includes a plurality of values of parameters that are settable by the user using the programmer, whereby the support customer has the sufficient information to answer the question.

3. The method of claim 1 wherein the requested data further includes a record of a plurality of actions performed by the system for a predetermined period of time in the past, whereby the support customer has the sufficient information to answer the question.

4. The method of claim 1 wherein the requested data further includes a record of a plurality of measurements made by the system for a predetermined period in the past, the measurements including at least one of temperatures, humidity, energy use, heating activity, cooling activity, circulation activity, lighting activity, appliance activity, and occupancy activity, whereby the support customer has the sufficient information to answer the question.

5. The method of claim 1 further comprising:
a) providing a means for assigning a unique identification code to the system and storing the identification code in the processor;
b) including the identification code in the requested data; and
c) providing a means for storing information related to the system, wherein the means for representing further includes a means to access and represent the stored information to the support person;
whereby the support person has the sufficient information to answer the question.

6. The method of claim 5 wherein the stored data includes the requested data from previous said calls, whereby the support person has information about previous support calls and is better prepared to provide a satisfactory answer.

7. A method of providing telephone support to a user of a home automation system comprising a processor, a programmer, a tone receiver, a modem, and a parallel connection to a household phone line, where the user has a problem programming the system and makes a call to a customer support provider, the support method comprising:
1) providing an automatic answering means for the call;
2) providing a means for automatically requesting the programmed data from the processor using a tone signal sent over the phone line and recognized by the tone receiver;
3) providing a software means in the processor, the software means responsive to the recognized tone signal and sending the programmed data using the modem and the phone line, the software means adapted to receive and use the programmed data using said modem and said phone line;
4) providing a means for receiving the programmed data;
5) assigning a support person to talk to the user;
6) providing the support person a means for viewing and modifying the programmed data;
7) using the phone line such that the support person and the user discuss the programming problem such that the support person is able to solve the programming problem by modifying the programmed data; and
8) using the phone line to send the modified programmed data to the processor;
whereby the programming problem is solved;
whereby the user can use the programmer to view the reprogrammed data; and
whereby the user is satisfied by the response of the customer support person and satisfied by the support method.

8. The method of claim 7 wherein the requested data further includes a record of a plurality of measurements made by the system for a predetermined period in the past, the measurements including at least one of temperatures, humidity, energy use, heating activity, cooling activity, circulation activity, lighting activity, appliance activity, and occupancy activity, whereby the support customer has the sufficient information to reprogram the system.

9. The method of claim 7 further comprising:
a) providing a means for assigning a unique identification code to the system and storing the identification code in the processor;
b) including the identification code in the requested data; and
c) providing a means for storing information related to the system;
wherein the means for representing further includes a means to access and represent the stored information to the support person;
whereby the support person has the sufficient information to reprogram the system.

10. The method of claim 9 where the means for storing information further includes a means for storing the programmed data sent to the system, whereby the means for storing information maintains a record of the reprogrammed data.

11. A method for providing an Internet access and control service for a home automation system, the automation system comprising a processor and a phone line interface, the interface connected in parallel to the household phone line, the interface controlled by the processor such that the automation system can answer an incoming phone call and establish digital data communications with a service provider call center, the method comprising:
1) providing an internet computer connected to the internet;
2) providing a web page using the Internet computer for the customer of the service, the web page accessible and controllable using a standard Internet connection and web browser;
3) providing a web enabled application that provides substantially the functionality of the home automation programmer used to program the automation system in the home;
4) providing a means for the Internet computer to place a phone call to the home of the automation system;
5) providing a means for the automation system to recognize the incoming phone call as a request for Internet access and establishing digital communications with the call center;
6) reading data from the automation system and displaying the data using the web enabled application such that the customer can access data from the automation system;
7) sending programming data entered by the customer using the web enabled application to the automation system; and
8) ending the phone call after the customer completes accessing and programming the automation system;
whereby the automation system is accessed and programmed using the Internet and the household phone line.

12. The method of claim 111 wherein said web page is personalized for each customer and the customer must enter a password to assess the web page;
whereby the web page can be adapted specifically to each system; and
whereby the customer can more easily interact with the system.

13. The method of claim 12 further comprising:
providing a means for storing information related to each automation system; and
making the stored information accessible from the web page;
whereby the customer can access information related to the automation system but not stored by the system.

14. A phone line interface, for a home automation system, that connects in parallel to a household phone line and functions compatibly with other telephone devices connected in parallel to the phone line, the interface controlled by the processor of the automation system, and the interface operating cooperatively with a service provider call center to provide at least one service of telephone customer support, remote programming, remote control using a telephone, remote control and access using an Internet connection, and automatic data reporting, the interface comprising:
1) a line interface unit means for electrically isolating the automation system from the phone line and for providing signal detection, signal conditioning, and signal generation necessary to answer, originate, and partake in phone calls on the phone line, the first means communicating with and controlled by the processor;
2) a tone receiver and transmitter means for detecting standard telephone dialing tones and call progress tones, and for generating and transmitting the dialing tones, the tone receiver and transmitter means connected to the conditioned signal from the line interface unit means, and communicating with and controlled by the processor; and
3) a modem means for decoding digital data sent on the phone line from the call center, and for encoding digital data for sending on the phone line to the call center, said the modem means connected to the conditioned signal from the line interface unit means, and communicating with and controlled by the processor;
whereby the call center can support the services using the interface; and
whereby household occupants are satisfied with the services provided.

15. A method whereby an internet service center programs a home automation system, the method comprising:
the internet service center providing a web page;
the internet service center receiving a hit to the web page;
the internet service center establishing a connection to the home automation system in response to the hit;
the internet service center programming the home automation system via the connection in response to data provided via the web page.

16. The method of claim 15 wherein:
establishing the connection comprises establishing a modem connection in a call over a telephone system.

17. The method of claim 16 further comprising:
if the programming fails because an entity other than the home automation system answers the call,
playing a recording requesting the occupant to remain quiet, and
re-attempting to program the home automation system via the modem connection.

18. The method of claim 15 further comprising:
protecting access to the web page by a password; and
preventing at least one of establishing the connection and programming the home automation system unless the password is given.

19. The method of claim 15 wherein:
the internet service center programs an HVAC characteristic of the home automation system.

20. A home automation controller for use with a home system and a conventional telephone system, the home automation controller comprising:
a phone line interface including,
a line interface unit adapted to (i) in response to a ringing signal of a call on the telephone system, answer the call if no other device answers the call, and (ii) in response to another device answering the call, connect to the telephone system in parallel with the other device, and
a tone receiver and transmitter adapted to detect multi-frequency telephone signals regardless of whether the line interface unit answered the call or connected in parallel with the other device; and
a processor, coupled to receive from the tone receiver and transmitter data identifying the received multi-frequency telephone signals, to perform at least one of accessing and controlling the home system in response to the received data.

21. The home automation controller of claim 20 wherein:
the home system comprises an HVAC system.

22. The home automation controller of claim 21 wherein:
the processor is adapted to recognize predetermined sequences of multi-frequency telephone signals, whereby a remote user can cause the home automation controller to have a predetermined effect upon the HVAC system by entering one of the predetermined sequences at a remote telephone which is connected to the telephone system.

23. A method for use in a system, the system including an electric utility, a customer appliance which consumes electricity, and a customer automation system which controls operation of the appliance, the method comprising:
the utility providing electricity to the appliance;
an entity sending a predetermined sequence of signals to the automation system over a conventional telephone system;
in response to the signals, the automation system causing the appliance to reduce its electricity consumption in a same manner in which a human operator would cause the appliance to reduce its electricity consumption via manual control of the automation system.

24. The method of claim 23 wherein:
the entity comprises a computer of the utility.

25. The method of claim 23 wherein:
the entity comprises a third party service provider.

26. The method of claim 23 wherein the system further includes multiple customer appliances and corresponding multiple customer automation systems, and wherein:
one of the utility and the entity maintains a list of different predetermined sequences of signals for the respective customer automation systems.

27. The method of claim 26 further comprising:
one of the utility and the entity selecting the different predetermined sequences of signals.

28. The method of claim 26 further comprising:
one of a customer and the customer's automation system selecting the different predetermined sequence of signals which are maintained in the list.

29. The method of claim 23 wherein:
the appliance is an HVAC system; and
the predetermined sequence of signals causes a given customer's automation system to reduce energy consumption by changing a target temperature range specified for rooms coupled to the HVAC system.

30. The method of claim 29 wherein:
the predetermined sequence of signals causes the given customer's automation system to reduce energy consumption by changing a target temperature range in only a proper subset of rooms coupled to the HVAC system.

31. The method of claim 29 wherein:
the reduction in energy consumption is temporary and terminates after one of a predetermined amount of time and a predetermined time.

32. The method of claim 29 further comprising:
the customer specifying parameters according to which the energy reduction is controlled.

33. The method of claim 32 wherein the parameters comprise at least one of:
an alternative temperature range; and
a specification of the rooms in which the temperature can be changed in response to the predetermined sequence of signals.

34. The method of claim 29 further comprising:
the utility providing an economic reward to the customers according to their reduced energy consumption.

35. The method of claim 34 wherein:
a given customer's automation system maintains a record of the reduced energy consumption and reports the record back to the utility; and
the economic reward is calculated in response to the record reported back.

36. A method of operating a home automation system which controls an HVAC system in a residence, wherein a telephone and the home automation system are coupled in parallel to a telephone line of the residence, the method comprising:
a person placing a call to a service provider via telephone connected to a telephone system, to request an adjustment to a temperature in the residence;
the home automation system automatically monitoring the telephone call;
the service provider receiving the telephone call;
the service provider sending a sequence of signals over the telephone system;
the home automation system detecting the sequence of signals; and
the home automation system altering operation of the HVAC system in response to the sequence of multi-frequency telephone signals.

37. The method of claim 36 wherein:
the service provider sending the sequence of signals is performed during and as part of the same call.

38. The method of claim 36 wherein:
the alteration of the HVAC system operation comprises changing a target temperature setting in at least one room of the residence.
